(19) United States
(12) Patent Application Publication
(10) Pub. No.: US 2025/0349020 A1
(43) Pub. Date: Nov. 13, 2025

(54) DEPTH-MAP ESTIMATION APPARATUS AND METHOD USING COMPLEX HOLOGRAM

(71) Applicant: Electronics and Telecommunications Research Institute, Daejeon (KR)

(72) Inventors: Ki Hong CHOI, Daejeon (KR); Tae One KIM, Daejeon (KR); Kee Hoon HONG, Daejeon (KR)

(21) Appl. No.: 19/201,710

(22) Filed: May 7, 2025

(30) Foreign Application Priority Data
May 7, 2024 (KR) 10-2024-0060003
Apr. 30, 2025 (KR) 10-2025-0057730

(51) Int. Cl. G06T 7/571

(52) U.S. Cl. CPC G06T 7/571; G06T 2207/20224

(57) ABSTRACT

Provided are a device and method for estimating a depth map using a complex hologram. The device includes a processor and a memory configured to store instructions executed by the processor. The processor generates a first all-in-focus image from a complex hologram using an all-in-focus image conversion algorithm, generates a second all-in-focus image from the complex hologram using a hologram generation technique for generating a hologram by numerically applying a Split-Lohmann optical system, and estimates a depth map in accordance with the first all-in-focus image and the second all-in-focus image.

### CROSS-REFERENCE TO RELATED APPLICATION

This application claims priority to and the benefit of Korean Patent Applications No. 10-2024-0060003 filed on May 7, 2024, and Korean Patent Applications No. 10-2025-0057730 filed on Apr. 30, 2025, the disclosure of which are incorporated herein by reference in their entirety.

### BACKGROUND

### 1. Field of the Invention

The present invention relates to an apparatus and method for estimating a depth map using a complex hologram.

### 2. Discussion of Related Art

Holography is a technology for recording the amplitude and phase information of light waves passing through a specific plane in a three-dimensional (3D) space.

Since digital image sensors are generally used to record light information and each pixel value only records the intensity value of light, a hologram is typically recorded using a phase-shifting interferometer to record a complex hologram containing light amplitude and phase information. When the recorded complex hologram has a phase distribution of an object within or close to [0 to 2 pi], a phase-unwrapping technique may be used to quantitatively determine the thickness/depth of an object. However, when the object becomes thicker or optical information space is recorded at a scale encountered in everyday life, it is difficult to determine the thickness of the object using only phase information.

Meanwhile, when 3D spatial light information is recorded by a self-interference holography system that records holograms using a general light source, there is a problem in that a phase change of an object in accordance with depth becomes uniform. Accordingly, it is difficult to estimate the depth of the object based on phase information alone. In addition, a depth sensor such as a time of flight (ToF) sensor, a lidar, or the like may be used. However, the depth sensor emits structured light and then collects it and thus is limited in terms of the range of structured light emission, and the depth sensor requires more brightness to emit the structured light in the presence of sunlight, which consumes high power. In addition, for military security purposes, such as surveillance, reconnaissance, and the like, using a depth sensor that emits structured light may lead to location exposure. A depth-from-defocus (DFD) technique may be applied to holographic images, but since the blur kernel has diffraction characteristics that differ from the Gaussian profile of a regular imaging system, it is difficult to extract a depth map by applying the DFD algorithm without changes.

### SUMMARY OF THE INVENTION

The present invention is directed to providing a device and method for estimating a depth map using a complex hologram that estimates an optimal depth map by updating a depth map to minimize a difference between an all-in-focus image generated from a complex hologram based on natural light and an all-in-focus image generated from the complex hologram on the basis of the depth map.

According to an aspect of the present invention, there is provided a device for estimating a depth map using a complex hologram, the device including a processor and a memory configured to store instructions executed by the processor. The processor generates a first all-in-focus image from a complex hologram using an all-in-focus image conversion algorithm, generates a second all-in-focus image from the complex hologram using a hologram generation technique (Split-Lohmann computer-generated holography (CGH)) for generating a hologram by numerically applying a Split-Lohmann optical system, and estimates a depth map in accordance with the first all-in-focus image and the second all-in-focus image.

The processor may update the depth map in accordance with a difference between the first all-in-focus image and the second all-in-focus image.

The processor may update the depth map to minimize the difference between the first all-in-focus image and the second all-in-focus image.

The processor may calculate a loss function for quantifying the difference between the first all-in-focus image and the second all-in-focus image and determine the amount of change in parameters using slope values of a previous loss function and a current loss function to minimize the loss function.

The processor may apply the hologram generation technique to the depth map to newly generate the second all-in-focus image and the depth map from the depth map.

The processor may calculate a phase ramp using the depth map, calculate a phase ramp image using the phase ramp, and then apply the hologram generation technique to the phase ramp image.

According to another aspect of the present invention, there is provided a method of estimating a depth map using a complex hologram, the method including acquiring, by a processor, a complex hologram and generating, by the processor, a first all-in-focus image from the complex hologram using an all-in-focus image conversion algorithm, generating a second all-in-focus image and a depth map from the complex hologram using a hologram generation technique for generating a hologram by numerically applying a Split-Lohmann optical system, and estimating the depth map in accordance with the first all-in-focus image and the second all-in-focus image.

The estimating of the depth map may include updating, by the processor, the depth map in accordance with a difference between the first all-in-focus image and the second all-in-focus image.

The estimating of the depth map may include updating, by the processor, the depth map to minimize the difference between the first all-in-focus image and the second all-in-focus image.

The estimating of the depth map may include calculating, by the processor, a loss function for quantifying the difference between the first all-in-focus image and the second all-in-focus image and determining the amount of change in parameters using slope values of a previous loss function and a current loss function to minimize the loss function.

The estimating of the depth map may include applying, by the processor, the hologram generation technique to the depth map to newly generate the second all-in-focus image and the depth map based on the depth map.

The estimating of the depth map may include calculating, by the processor, a phase ramp using the depth map, calculating a phase ramp image using the phase ramp, and then applying the hologram generation technique to the phase ramp image.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a block diagram of a device for estimating a depth map using a complex algorithm according to an exemplary embodiment of the present invention;

FIG. 2 is a diagram schematically showing a process of estimating a depth map according to an exemplary embodiment of the present invention; and

FIG. 3 is a flowchart illustrating a method of estimating a depth map using a complex algorithm according to an exemplary embodiment of the present invention.

### DETAILED DESCRIPTION OF EXEMPLARY EMBODIMENTS

Hereinafter, a device and method for estimating a depth map using a complex algorithm according to exemplary embodiments of the present invention will be described. In this process, the thicknesses of lines, the sizes of components, and the like shown in the drawings may be exaggerated for the purpose of clarity and convenience of description. Moreover, terms used herein are defined in consideration of functions in the present invention, and the terms may vary depending on the intention of a user or operator or precedents thereof. Therefore, these terms are to be defined on the basis of the overall content of the specification.

The present invention may be implemented in a variety of different forms and is not limited to the embodiments described herein. To clearly describe the present invention, parts irrelevant to the description will be omitted from the drawings, and throughout the specification, like reference numerals refer to like elements.

Throughout the specification, when a part is referred to as “including” a component, other components are not excluded but may be included unless particularly described otherwise.

The description of this specification may be implemented using, for example, a method or process, a device, a software program, a data stream, or a signal. Even if a feature is discussed only in a single form of implementation (e.g., discussed only as a method), the discussed feature may be implemented in another form (e.g., a device or program). The device may be implemented appropriately as hardware, software, firmware, etc. The method may be implemented in a device such as a processor which generally refers to a processing device including, for example, a computer, a microprocessor, an integrated circuit, a programmable logic device, etc.

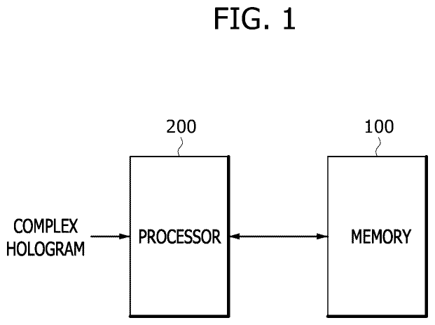

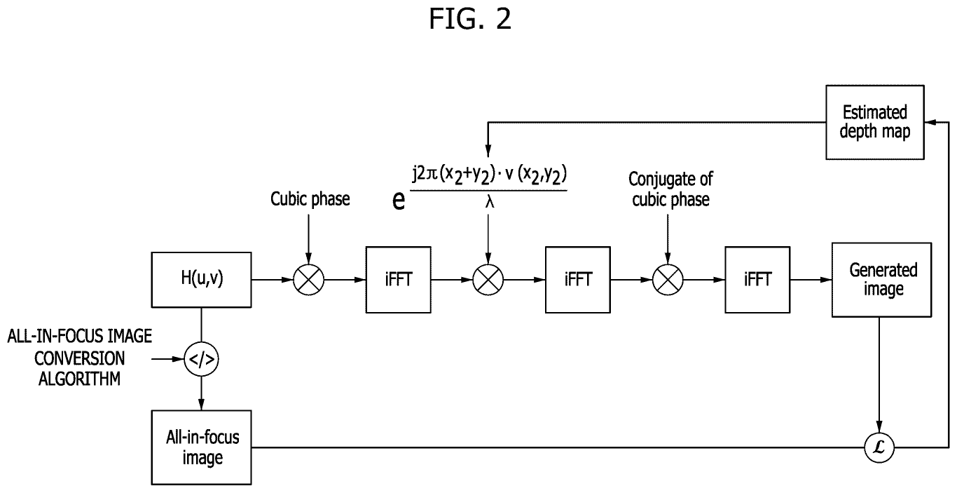

FIG. 1 is a block diagram of a device for estimating a depth map using a complex algorithm according to an exemplary embodiment of the present invention, and FIG. 2 is a diagram schematically showing a process of estimating a depth map according to an exemplary embodiment of the present invention.

Referring to FIG. 1, the device for estimating a depth map using a complex algorithm according to the exemplary embodiment of the present invention may include a memory 100 and a processor 200.

The memory 100 may store various data used by the processor 200. The data may include instructions that cause operations, steps, or the like according to an embodiment of the present invention to be performed. In other words, the memory 100 may store instructions to update a depth map such that a difference between an all-in-focus image generated from a complex hologram based on natural light and an all-in-focus image generated using a Split-Lohmann hologram generation formula may be minimized. The depth map may be used for providing three-dimensional (3D) spatial information to generate a complex hologram.

The memory 100 may include at least one storage medium among a flash memory type, a hard disk type, a multimedia card micro type, a card type of memory, a random access memory (RAM), a static random access memory (SRAM), a read-only memory (ROM), a programmable read-only memory (PROM), an erasable programmable read-only memory (EPROM), and an electrically erasable programmable read-only memory (EEPROM).

The processor 200 may be connected to the memory 100 and execute the instructions stored in the memory 100. The processor 200 may execute the instructions stored in the memory 100 to control at least one other component (e.g., a hardware or software component) connected to the processor 200 and perform various kinds of data processing or computation.

Moreover, a configuration of the processor 200 for performing each function may be distinguished at a hardware, software, or logic level. In this case, dedicated hardware may be used to perform each function. To this end, the processor 200 may be implemented as or include at least one of an application specific integrated circuit (ASIC), a digital signal processor (DSP), a programmable logic device (PLD), a field programmable gate array (FPGA), a central processing unit (CPU), a microcontroller, and a microprocessor.

The processor 200 may be implemented as a CPU or a system on chip (SoC) and may run an operating system (OS) or application to control a plurality of hardware or software components connected to the processor 200 and perform various kinds of data processing and computation. The processor 200 may be configured to execute at least one instruction stored in the memory 100 and store the execution result data in the memory 100.

The processor 200 may acquire a complex hologram. In this case, the processor 200 may numerically generate the complex hologram based on an input signal or optically acquire the complex hologram.

A method of numerically generating a complex hologram may include an angular spectrum method (ASM), a Fresnel diffraction method, and the like.

According to a method of optically generating a complex hologram, a scan beam may be emitted toward a target object, an electrical signal which is proportional to the light intensity of the scan beam reflected from the target object may be stored in accordance with a scanning position, and hologram information of the target object may be generated on the basis of the stored electrical signal.

Since a method of acquiring a complex hologram is well-known to those of ordinary skill in the art, a detailed description thereof will be omitted.

The processor 200 may generate a first all-in-focus image from the complex hologram using an all-in-focus image conversion algorithm for generating a first all-in-focus image from a complex hologram.

The all-in-focus image conversion algorithm may be at least one of the Fresnel diffraction method, the ASM, a depth map-based rendering method, a deep learning-based approach, and a multi-focus fusion method.

According to the Fresnel diffraction method, a Fresnel approximation formula may be applied to a complex hologram to generate reconstruction images at various distances, and subsequently in-focus regions are fused together.

According to the ASM, a hologram is decomposed into a plane wave spectrum, and subsequently each component is propagated to a target depth to extract a focal region.

According to the depth map-based rendering method, depth information extracted from a complex hologram is utilized to generate a focal region mask, depth maps for each of red-green-blue (RGB) channels are combined to correct chromatic aberration, and subsequently a multi-focal image is composited.

According to the deep learning-based approach, an all-in-focus image is generated directly from a complex hologram using a structure such as a U-net or the like.

According to the multi-focus fusion method, sharpness maps of images reconstructed on several focal planes are calculated and then integrated in a weighted average fashion.

The all-in-focus image conversion algorithm is not limited to the foregoing examples.

The processor 200 may generate a second all-in-focus image from the complex hologram using a hologram generation technique (Split-Lohmann computer-generated holography (CGH)) for generating a hologram by numerically applying a Split-Lohmann optical system.

The Split-Lohmann optical system may image light information of a two-dimensional (2D) plane to a 3D space pixel by pixel by digitally applying a Lohmann-Alvarez lens (hereinafter “Lohmann lens”).

As for the Lohmann lens, two cubic phase-plates are superimposed on each other, and the two superimposed elements are moved horizontally or rotated to change an overall focal length.

In the Split-Lohmann optical system, superimposed Lohmann lenses are separated and placed on both ends of a 4f optical system to achieve the same optical effect. Here, horizontal movement of the two elements is made using a phase-only spatial light modulator (SLM) which is located at the center of the 4f optical system. More specifically, when a spatially variable phase ramp is generated as a phase image and output to the phase-only SLM, the pixel-by-pixel light information of the 2D spatial light information incident on the 4f optical system is relayed to different positions in the SLM, modulated by encountering phase ramps of different components, and relayed again and output out of the optical system. Here, since the modulation of the phase ramps through two cubic phase-plates has the effect of passing through the lenses with different focal lengths, 2D light information is imaged at different depths spatially at an output end of the 4f optical system. In a 3D display to which this is applied, a flat-panel micro-organic light emitting diode (OLED) display is placed at an input end of the optical system, and a cubic phase-plate and a phase-only SLM are used to image pixels of the OLED at different depths to reproduce 3D light information.

Meanwhile, as a technique for generating a hologram in a reverse manner, a hologram generation technique (Split-Lohmann CGH) for generating a complex hologram by numerically applying a Split-Lohmann optical system (hereinafter, “hologram generation technique”) has been proposed. The hologram generation technique may be utilized to generate a second all-in-focus image based on the complex hologram.

According to the hologram generation technique, a 2D all-in-focus image is at an input end of an optical system, and the optical system for replacing a depth map with a phase ramp image changed with a phase ramp may be simulated in place of a phase-only SLM such that a hologram may be obtained as an output value. This hologram generation technique uses an all-in-focus image and a depth map to generate holographic information for all depths through a single computation, and thus the computation time is independent of the number of depths to be expressed.

Specifically, when a depth map d(x, y) is given, the processor 200 may generate a phase ramp z(x, y) by applying the depth map d(x, y) to Equation 1 below.

$$z ( x , y ) = α \frac{d ( x , y )}{{d}_{max}} \qquad [ Equation 1 ]$$

Here, α represents a slope of the phase ramp, and dₘₐₓ represents a duty cycle limit.

The phase ramp z(x, y) may be converted into a phase ramp image v(x, y) using Equation 2 below.

$$v ( x , y ) = - \frac{z ( z , y ) {c}_{0}}{6 {f}_{0}^{3}} \qquad [ Equation 2 ]$$

Here, c₀ may represent a system parameter which is a constant related to the speed, the refractive index, or the like of light, and f₀ may represent a system parameter which is a constant related to a frequency, a distance, or the like.

The processor 200 may generate a complex hologram from the all-in-focus image and the phase ramp image z(x, y) derived from the depth map d(x, y) using Equation 3 below.

$$H ( u , v ) = {e}^{\frac{i 2 π ( {u}^{3} + {v}^{3} )}{λ {c}_{0}}} \cdot FFT \{ {e}^{\frac{- i 2 π ( {x}_{2} + {y}_{2} ) \cdot v ( {x}_{2} , {y}_{2} )}{λ}} \cdot FFT \{ {e}^{\frac{- i 2 π ( {x}_{1}^{3} + {y}_{1}^{3} )}{λ {c}_{0}}} \cdot FFT [ A ( x , y ) \cdot {e}^{i φ ( xy )} ] \} \} \qquad [ Equation 3 ]$$

Here, A(x, y) represents a pixel-specific intensity value of the all-in-focus image, and e^{iφ(x,y)} represents an initial phase. To generate a hologram using a Split-Lohmann optical system, a random phase value may be used as an initial phase.

$${e}^{\pm \frac{i 2 π ( {ξ}^{3} + {η}^{3} )}{λ {c}_{0}}}$$

represents a cubic phase.

$${e}^{\frac{- i 2 π ( {x}_{2} + {y}_{2} ) \cdot v ( {x}_{2} , {y}_{2} )}{λ}}$$

represents phase information of complex waves at specific coordinates in the phase ramp image. In particular,

$${e}^{\frac{- i 2 π ( {x}_{2} + {y}_{2} ) \cdot v ( {x}_{2} , {y}_{2} )}{λ}}$$

may change in accordance with the phase ramp image derived from the depth map. Therefore, the complex hologram derived using Equation 3 may change in accordance with a phase ramp image derived from a depth map that has been changed. During this process, the processor 200 may generate a second all-in-focus image.

The processor 200 may extract a difference between the first all-in-focus image and the second all-in-focus image. The processor 200 may update the depth map such that the difference between the first all-in-focus image and the second all-in-focus image may be minimized. To this end, the processor 200 may use gradient descent. In other words, the processor 200 may calculate a loss function on the basis of system parameters using mean square error (MSE). The loss function is a value obtained by quantifying the difference between the first all-in-focus image and the second all-in-focus image. The processor 200 determines the amount of change in the parameters using slope values of a previous loss function and the current loss function such that the loss function may be minimized.

Here, the processor 200 may continuously update the depth map on the basis of an iterative computation structure for updating a depth map to minimize a loss function, deriving a phase ramp image from the updated depth map using Equations 1 and 2, applying a Split-Lohmann hologram generation formula such as Equation 3 to the derived phase ramp image to generate a second all-in-focus image, and then updating the depth map to minimize a difference between a first all-in-focus image and the second all-in-focus image.

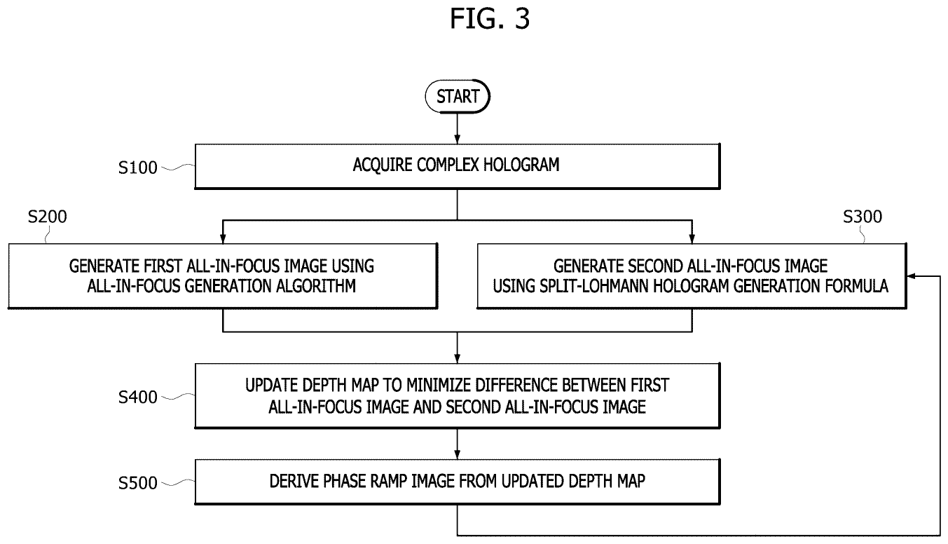

A method of estimating a depth map using a complex algorithm according to an exemplary embodiment of the present invention will be described below with reference to FIG. 3.

FIG. 3 is a flowchart illustrating a method of estimating a depth map using a complex algorithm according to an exemplary embodiment of the present invention.

Referring to FIG. 3, the processor 200 may acquire a complex hologram (S100).

The processor 200 may generate a first all-in-focus image from the acquired complex hologram. In this case, the processor 200 may generate the first all-in-focus image using at least one of a Fresnel diffraction method, an ASM, a depth map-based rendering method, a deep learning-based approach, and a multi-focus fusion method (S200).

The processor 200 may generate a second all-in-focus image from the complex hologram using a hologram generation technique (Split-Lohmann CGH) for generating a hologram by numerically applying a Split-Lohmann optical system (S300).

The processor 200 may update a depth map to minimize a difference between the first all-in-focus image and the second all-in-focus image (S400). In this case, the processor 200 may use gradient descent. In other words, the processor 200 may calculate a loss function on the basis of system parameters using MSE, and determine the amount of change in the parameters using slope values of a previous loss function and the current loss function such that the loss function may be minimized.

Subsequently, the processor 200 may derive a phase ramp from the updated depth map using Equation 1 and derive a phase ramp image from the derived phase ramp using Equation 2 (S500).

The processor 200 may generate the second all-in-focus image by applying the derived phase ramp image to a hologram generation technique such as Equation 3 (S300).

As described above, the processor 200 can continuously update the depth map on the basis of an iterative computation structure for updating a depth map to minimize a difference between the generated second all-in-focus image and the first all-in-focus image.

In this way, a device and method for estimating a depth map using a complex algorithm according to exemplary embodiments of the present embodiments estimate an optimal depth map by updating a depth map to minimize a difference between an all-in-focus image generated from a complex hologram based on natural light and an all-in-focus image obtained from the complex hologram on the basis of the depth map, and improve the picture quality of a noncoherent hologram recording system on the basis of the updated depth map.

A device and method for estimating a depth map using a complex algorithm according to aspects of the present embodiments update a depth map to minimize a difference between an all-in-focus image generated from a complex hologram based on natural light and an all-in-focus image generated using a Split-Lohmann hologram generation formula and improve the picture quality of a noncoherent hologram recording system on the basis of the updated depth map.

Although the present invention has been described above with reference to embodiments illustrated in the drawings, the embodiments are merely illustrative, and those of ordinary skill in the art should understand that various modifications and other equivalent embodiments can be made based on the embodiments. Therefore, the technical scope of the present invention should be determined based on the following claims.

What is claimed is:

1. A device for estimating a depth map using a complex hologram, the device comprising:
a processor; and
a memory configured to store instructions executed by the processor,
wherein the processor generates a first all-in-focus image from a complex hologram using an all-in-focus image conversion algorithm, generates a second all-in-focus image from the complex hologram using a hologram generation technique (Split-Lohmann computer-generated holography (CGH)) for generating a hologram by numerically applying a Split-Lohmann optical system, and estimates a depth map in accordance with the first all-in-focus image and the second all-in-focus image.

2. The device of claim 1, wherein the processor updates the depth map in accordance with a difference between the first all-in-focus image and the second all-in-focus image.

3. The device of claim 2, wherein the processor updates the depth map to minimize the difference between the first all-in-focus image and the second all-in-focus image.

4. The device of claim 3, wherein the processor calculates a loss function for quantifying the difference between the first all-in-focus image and the second all-in-focus image, and determines an amount of change in parameters using slope values of a previous loss function and a current loss function to minimize the loss function.

5. The device of claim 2, wherein the processor applies the hologram generation technique to the depth map to newly generate the second all-in-focus image and the depth map from the depth map.

6. The device of claim 5, wherein the processor calculates a phase ramp using the depth map, calculates a phase ramp image using the phase ramp, and then applies the hologram generation technique to the phase ramp image.

7. A method of estimating a depth map using a complex hologram, the method comprising:
acquiring, by a processor, a complex hologram; and
generating, by the processor, a first all-in-focus image from the complex hologram using an all-in-focus image conversion algorithm, generating a second all-in-focus image and a depth map from the complex hologram using a hologram generation technique for generating a hologram by numerically applying a Split-Lohmann optical system, and estimating the depth map in accordance with the first all-in-focus image and the second all-in-focus image.

8. The method of claim 7, wherein the estimating of the depth map comprises updating, by the processor, the depth map in accordance with a difference between the first all-in-focus image and the second all-in-focus image.

9. The method of claim 8, wherein the estimating of the depth map comprises updating, by the processor, the depth map to minimize the difference between the first all-in-focus image and the second all-in-focus image.

10. The method of claim 9, wherein the estimating of the depth map comprises calculating, by the processor, a loss function for quantifying the difference between the first all-in-focus image and the second all-in-focus image, and determining an amount of change in parameters using slope values of a previous loss function and a current loss function to minimize the loss function.

11. The method of claim 8, wherein the estimating of the depth map comprises applying, by the processor, the hologram generation technique to the depth map to newly generate the second all-in-focus image and the depth map from the depth map.

12. The method of claim 11, wherein the estimating of the depth map comprises calculating, by the processor, a phase ramp using the depth map, calculating a phase ramp image using the phase ramp, and then applying the hologram generation technique to the phase ramp image.
